(19) United States
(12) Patent Application Publication
(10) Pub. No.: US 2010/0027218 A1
(43) Pub. Date: Feb. 4, 2010

(54) PORTABLE COMPUTER WITH A ROTARY HANDLE

(76) Inventors: Li-Sheng Lin, Taipei Hsien (TW); Cheng-Hsiang Chuang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/389,353

(22) Filed: Feb. 19, 2009

(30) Foreign Application Priority Data
Jul. 31, 2008 (TW) 097213568

(51) Int. Cl. G06F 1/16

(52) U.S. Cl. 361/679.59

(57) ABSTRACT

A portable computer includes a host including a housing, a rotary handle connected to the housing in a rotatable manner, and a monitor pivoted to the host.

### BACKGROUND OF THE INVENTION

1. Field of the Invention

The present invention relates to a portable computer, and more particularly, to a portable computer with a rotary handle.

2. Description of the Prior Art

In modern information society, portable electronic devices are widely used in every field. A large quantity of data is communicated, processed, and stored in digital data format, thus computers used for reading and accessing data have become very important tools. Especially portable computers, such as notebooks, allow users to carry at any place by their small size, lightness, and portability. However the portable computers burden the user heavily when carrying them by hands for a long time. There is a need for mechanical design to provide the user to carry the portable computer easily.

### SUMMARY OF THE INVENTION

According to the claimed invention, a portable computer includes a host including a housing, a rotary handle connected to the housing in a rotatable manner, and a monitor pivoted to the host.

According to the claimed invention, a slot is formed on the housing for containing the rotary handle.

According to the claimed invention, the slot is an U-shaped slot.

According to the claimed invention, the portable computer further includes a fixing mechanism for fixing the rotary handle in the slot.

According to the claimed invention, the fixing mechanism includes a first magnetic component installed inside the rotary handle, and a second magnetic component installed inside the housing for attracting the first magnetic component so as to fix the rotary handle in the slot when the rotary handle is contained in the slot.

According to the claimed invention, the first magnetic component is a magnet.

According to the claimed invention, the second magnetic component is a magnet.

According to the claimed invention, the rotary handle is made of metal material and the portable computer further includes a second magnetic component installed inside the housing for attracting the rotary handle so as to fix the rotary handle in the slot when the rotary handle is contained in the slot.

According to the claimed invention, the portable computer is a notebook computer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 3 are schematic drawings of a portable computer at different conditions according to a preferred embodiment of the present invention.

FIG. 4 is a schematic drawing of the portable computer capable of being carried according to the preferred embodiment of the present invention.

FIG. 5 is a schematic drawing of a rotary handle according to the preferred embodiment of the present invention.

FIG. 6 is a drawing of inner structure of a housing according to the preferred embodiment of the present invention.

FIG. 7 is a sectional view of the rotary handle containing in a slot on the housing according to the preferred embodiment of the present invention.

### DETAILED DESCRIPTION

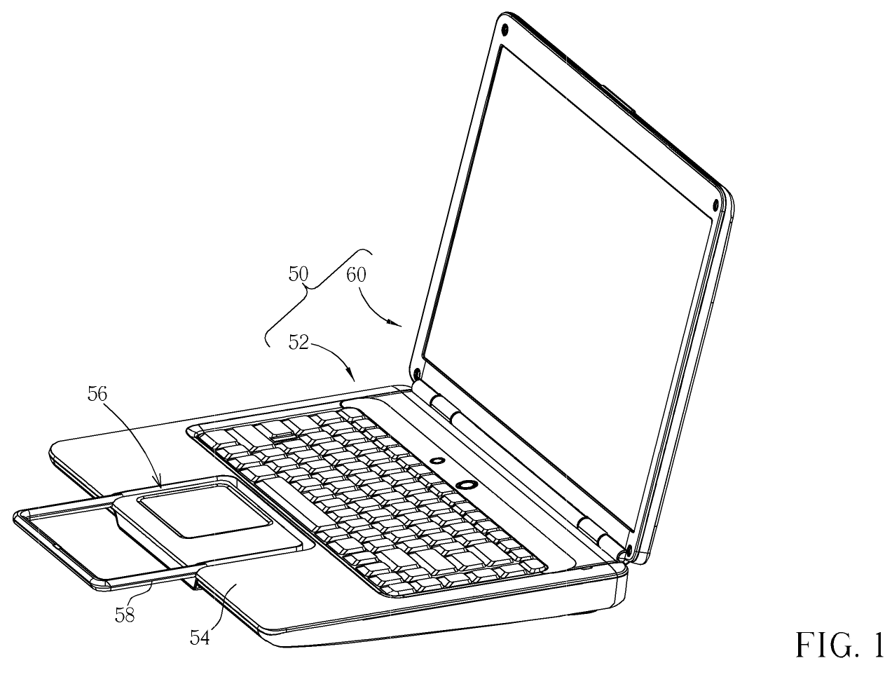

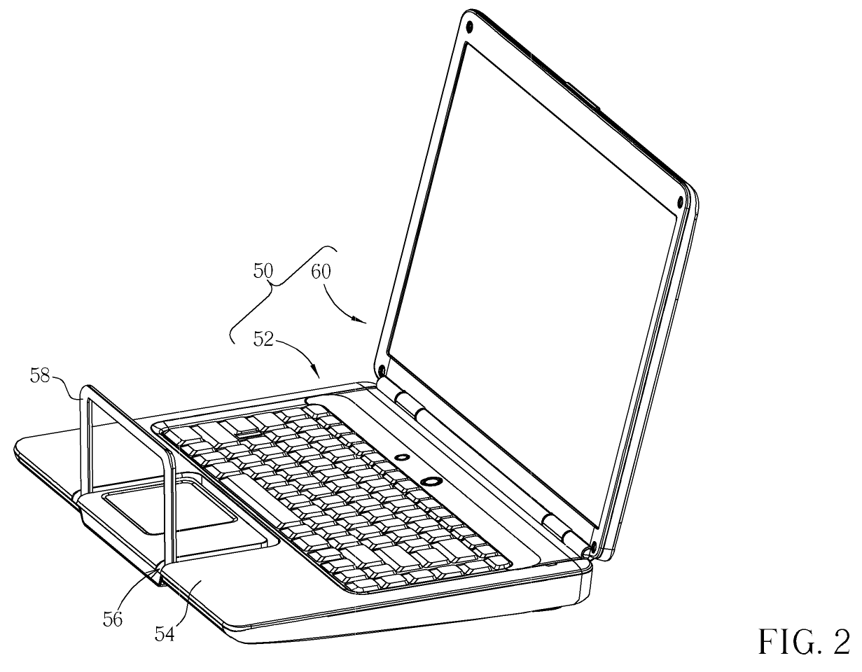

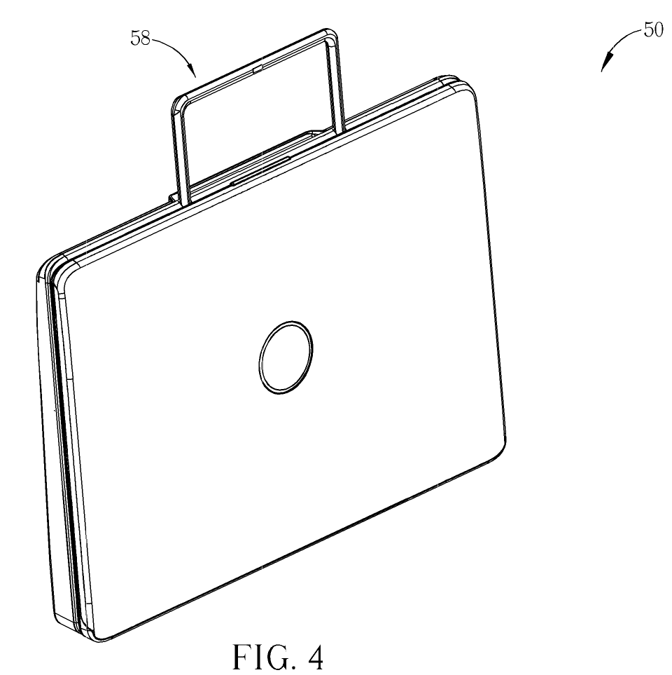

Please refer to FIG. 1 to FIG. 3. FIG. 1 to FIG. 3 are schematic drawings of a portable computer 50 at different conditions according to a preferred embodiment of the present invention. The portable computer 50 can be a notebook computer. The portable computer 50 includes a host 52 including a housing 54. A slot 56 is formed on the housing 54, and the slot 56 can be an U-shaped slot. The portable computer 50 further includes a rotary handle 58 connected to the housing 54 in a rotatable manner, such as being pivoted to the housing 54. The portable computer 50 further includes a monitor 60 pivoted to the host 52. As shown in FIG. 1 to FIG. 3, the rotary handle 58 can be rotated at different angles relative to the housing 54. When a user wants to carry the portable computer 50, the rotary handle 58 can be rotated to expose out of the host 52 as shown in FIG. 1. Please refer to FIG. 4. FIG. 4 is a schematic drawing of the portable computer 50 capable of being carried according to the preferred embodiment of the present invention. The user can hold the rotary handle 58 to carry the portable computer 50. When the rotary handle 58 is rotated to be contained in the slot 56 on the housing 54, the rotary handle 58 can not be exposed out of the housing 54 and can be hidden inside the slot 56 so as to main aesthetic feeling of outward appearance of the portable computer 50.

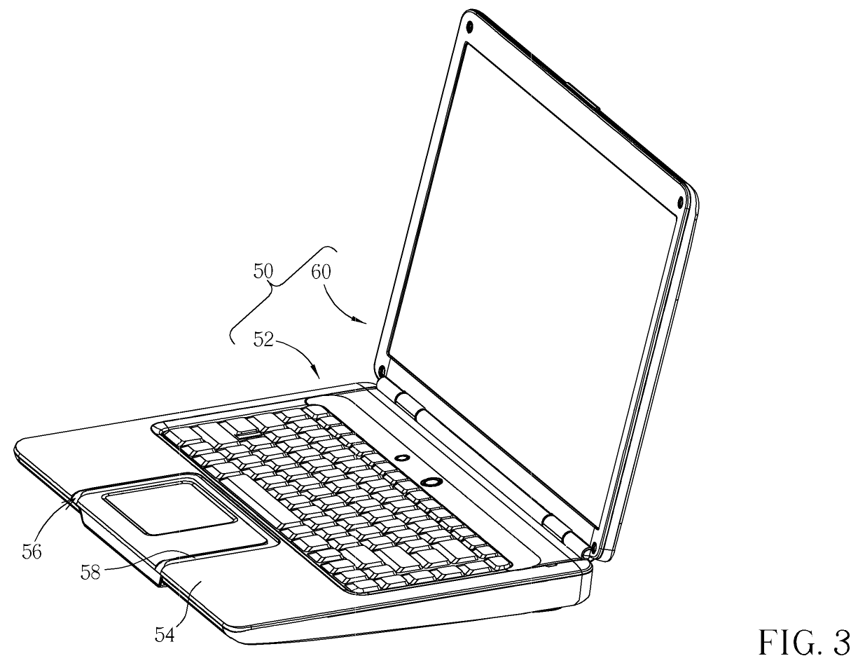

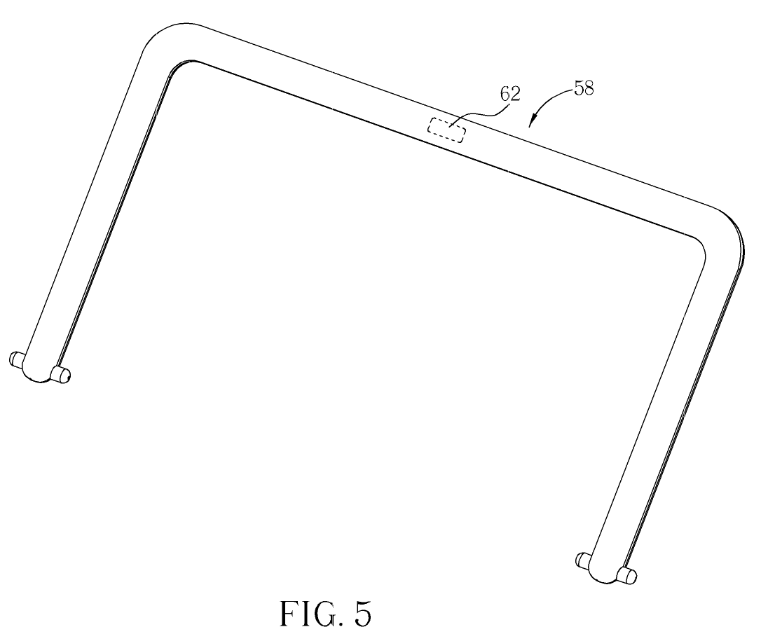

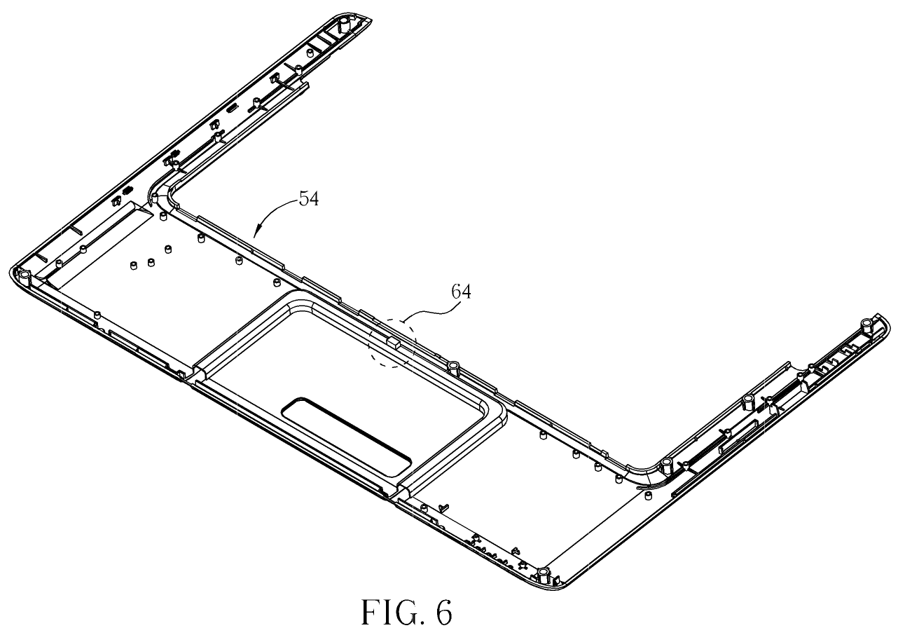

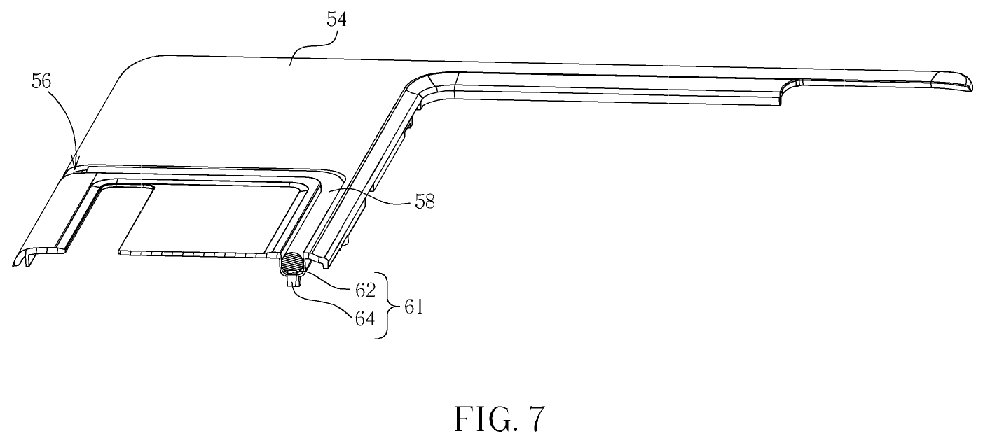

Please refer to FIG. 5 to FIG. 7. FIG. 5 is a schematic drawing of the rotary handle 58 according to the preferred embodiment of the present invention. FIG. 6 is a drawing of inner structure of the housing 54 according to the preferred embodiment of the present invention. FIG. 7 is a sectional view of the rotary handle 58 containing in the slot 56 on the housing 54 according to the preferred embodiment of the present invention. The portable computer 50 further includes a fixing mechanism 61 for fixing the rotary handle 58 in the slot 56. The fixing mechanism 61 includes a first magnetic component 62 installed inside the rotary handle 58, and a second magnetic component 64 installed inside the housing 54. The first magnetic component 62 and the second magnetic component 64 can be a magnet respectively. When the rotary handle 58 rotates to be contained in the slot 56 on the housing 54 as shown in FIG. 3 and FIG. 7, the second magnetic component 64 can attract the first magnetic component 62 so as to fix the rotary handle 58 on the housing 54. Therefore, the rotary handle 58 can not separate from the slot 56 on the housing 54 easily. In addition, the rotary handle 58 can be made of metal material, and the first magnetic component 62 can be disposed selectively. That is, the second magnetic component 64 can attract the rotary handle 58 directly so as to fix the rotary handle 58 in the slot 56 on the housing 54 when the rotary handle 58 is contained in the slot 56. The fixing mechanism of the present invention for fixing the rotary handle 58 on the housing 54 can be substituted by other mechanism instead of the magnetic mechanism, such as a mechanism of protrusion and corresponding indentation.

Besides, the rotary handle 58 can be disposed on other positions of the housing 54, such as on other side of the housing 54, or on the monitor 62. The working principle thereof is the same as the above-mentioned embodiment, and a further description is hereby omitted. The mechanical design of disposition of the rotary handle on the portable computer is within the scope of the present invention.

In contrast to the prior art, the present invention provides the rotary handle on the portable computer so that the user can carry the portable computer easily and conveniently. It's a labor-saving mechanical design. Besides, various patterns or slogans can be formed on the rotary handle so as to increase aesthetic feeling of outward appearance or to advertise the portable computer.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A portable computer comprising:
a host including a housing;
a rotary handle connected to the housing in a rotatable manner; and
a monitor pivoted to the host.

2. The portable computer of claim 1 wherein a slot is formed on the housing for containing the rotary handle.

3. The portable computer of claim 2 wherein the slot is an U-shaped slot.

4. The portable computer of claim 2 further comprising a fixing mechanism for fixing the rotary handle in the slot.

5. The portable computer of claim 4 wherein the fixing mechanism comprises:
a first magnetic component installed inside the rotary handle; and
a second magnetic component installed inside the housing for attracting the first magnetic component so as to fix the rotary handle in the slot when the rotary handle is contained in the slot.

6. The portable computer of claim 5 wherein the first magnetic component is a magnet.

7. The portable computer of claim 5 wherein the second magnetic component is a magnet.

8. The portable computer of claim 2 wherein the rotary handle is made of metal material and the portable computer further comprises:
a second magnetic component installed inside the housing for attracting the rotary handle so as to fix the rotary handle in the slot when the rotary handle is contained in the slot.

9. The portable computer of claim 8 wherein the second magnetic component is a magnet.

10. The portable computer of claim 1 further comprising a fixing mechanism for fixing the rotary handle on the housing.

11. The portable computer of claim 10 wherein the fixing mechanism comprises:
a first magnetic component installed inside the rotary handle; and
a second magnetic component installed inside the housing for attracting the first magnetic component so as to fix the rotary handle on the housing.

12. The portable computer of claim 11 wherein the first magnetic component is a magnet.

13. The portable computer of claim 11 wherein the second magnetic component is a magnet.

14. The portable computer of claim 1 wherein the rotary handle is made of metal material and the portable computer further comprises:
a second magnetic component installed inside the housing for attracting the rotary handle so as to fix the rotary handle on the housing.

15. The portable computer of claim 14 wherein the second magnetic component is a magnet.

16. The portable computer of claim 1 being a notebook computer.
